(19) United States
(12) Patent Application Publication
(10) Pub. No.: US 2025/0290885 A1
(43) Pub. Date: Sep. 18, 2025

(54) EX-SITU DEVICE FOR MEASUREMENTS OF LIQUID-CONTAINER RELATIONSHIPS

(71) Applicant: The Texas A&M University System, College Station, TX (US)

(72) Inventors: Daniel Watson, College Station, TX (US); Pavel Tsvetkov, College Station, TX (US)

(21) Appl. No.: 18/608,584

(22) Filed: Mar. 18, 2024

(51) Int. Cl. G01N 27/07; G01F 23/24; G01M 3/16; G01N 27/48

(52) U.S. Cl. CPC G01N 27/07; G01F 23/241; G01M 3/16; G01N 27/48

(57) ABSTRACT

An ex-situ measurement system includes an ex-situ measurement apparatus. The ex-situ measurement apparatus includes a plurality of electrodes mounted along the exterior surface of liquid-containing process equipment. The ex-situ measurement apparatus is configured to conduct an electrical signal through a series of circuits defined by the plurality of electrodes and a segments of the liquid-containing structure spanning therebetween. The ex-situ measurement detection apparatus further includes a computing device configured to detect a change in the electrical signal from the circuits and correlate the change in the electrical signal with baseline electrical signals to prescribe one or more liquid container parameters, such as fluid level, fluid corrosivity, fluid species, coating health, void fraction, and fluid leakage.

### TECHNICAL FIELD

The described examples relate generally to systems, devices, and techniques for measuring liquid-container relationships in process equipment using external measurement devices.

### BACKGROUND

Molten salt reactors (MSRs) offer an approach to nuclear power that utilizes molten salts as their nuclear fuel in place of the conventional solid fuels used in light water reactors. Advantages include efficient fuel utilization and enhanced safety (in part due to replacing water as a coolant with molten salt). In some MSRs, fission reactions occur within a molten salt composition housed within a reactor vessel. The reactor vessel may carry hazardous substances, including substances that may be radioactive. It may therefore be desirable to continuously monitor and inform reactor vessel states, such as fluid level, fluid corrosivity, fluid species, coating health, void fraction, and fluid leakage, to system administrators for the safe and stable operation of the MSRs. Currently only a limited list of qualified sensors exists for in-situ deployment within the MSRs. Ex-situ sensors for fluid levels have been investigated with acoustic sensors but are susceptible to system vibrations and involve moving parts at high temperatures within high radiation environments. As such, there remains a need for developing a non-moving and non-intrusive ex-situ system and apparatus that can conduct accurate measurements on the liquid-containing process equipment.

### SUMMARY

In one example, an ex-situ system for measuring liquid-container relationships is disclosed. The ex-situ measurement system includes a series of spaced electrodes affixed to an exterior surface of a liquid-containing structure. Each adjacent pair of electrodes of the series of spaced electrodes form a circuit with a segment of the liquid-containing structure spanning therebetween. The ex-situ measurement system further includes a computing device that is configured to detect a change in an electrical signal from each circuit and associate the change with a change in a liquid-container parameter.

In another example, the liquid-container parameter may include a liquid level of the liquid-containing structure.

In another example, the liquid-container parameter may include a liquid corrosivity of a liquid of the liquid-containing structure.

In another example, the liquid-container parameter may include a liquid species of a liquid of the liquid-containing structure.

In another example, wherein the liquid-container parameter may include a coating health of a coating of the liquid-containing structure.

In another example, the liquid-container parameter may include a void fraction of the liquid-containing structure.

In another example, the liquid container parameter may include an indication of a liquid leak of a liquid of the liquid-containing structure.

In another example, each circuit may be associated with a baseline electrical resistance through the corresponding segment of the liquid-containing structure. The change in the electric signal from each circuit is based on a change in a measured electrical resistance between two adjacent electrodes and through the liquid-containing structure relative to the corresponding baseline electrical resistance for the circuit.

In another example, each adjacent pair of electrodes forms a secondary circuit with a portion of a volume of the liquid-containing structure corresponding to the respective segment.

In another example, the computing device is configured to detect a change in an electrical signal from each secondary circuit and associate said change with a change in the liquid-container parameter.

In another example, each secondary circuit may be associated with a baseline electrical resistance through the corresponding portion of the volume of the liquid-containing structure. The change in the electric signal from each secondary circuit is based on a change in a measured electrical resistance between two adjacent electrodes and through the corresponding portion of the volume of the liquid-containing structure relative to the corresponding baseline electrical resistance for the secondary circuit.

In another example, the computing device is configured to detect and monitors changes of electrical resistance values between the adjacent electrodes.

In another example, the computing device is configured to apply impedance spectroscopy to detect the change in the electrical signal, wherein the impedance spectroscopy is used to monitor changes of electrical resistance values between the adjacent electrodes in different signal frequencies.

In another example, the computing device is configured to apply cyclic voltammetry to detect the change in the electrical signal, wherein the cyclic voltammetry is used to monitor changes of electric currents in different voltage inputs.

In another example, the computing device is configured to apply open-circuit potential to detect the change in the electrical signal, wherein the open-circuit potential is used to monitors changes of electric potentials between the adjacent electrodes.

In another example, the computing device is configured to measure the latent current to detect the change in the electrical signal, wherein the latent current is used to monitor the presence and changes of electric currents between the adjacent electrodes.

In another example, a method of detecting a change in a liquid-container parameter is disclosed. The method operates a process to fill in a liquid-containing structure with a quantity of liquid, wherein the liquid-containing structure is associated with a series of spaced electrodes mounted along and electrically coupled with a side of the liquid-containing structure. Then the method operates a process to supply an electrical signal through a series of circuits defined by corresponding adjacent pairs of electrodes of the series of spaced electrodes and a segments of the liquid-containing structure spanning therebetween. Later the method operates a process to detect a change in the electrical signal from one or more circuits of the series of circuits and associate the change with a change in a liquid-container parameter.

In another example, each circuit is further defined by a portion of a volume of the liquid-containing structure corresponding to the respective segment such that the portion of the volume and the corresponding segment of the liquid-containing structure form a parallel resistive circuit.

In another example, the liquid container parameter may include one or more of a liquid level of the liquid-containing structure, a liquid corrosivity of a liquid of the liquid-containing structure, a liquid species of a liquid of the liquid-containing structure, a coating health of a coating of the liquid-containing structure, a void fraction of the liquid-containing structure, or an indication of a liquid leak of a liquid of the liquid-containing structure.

In another example, the detecting further comprises detecting a change in the electrical resistance of the electrical signal, and the associating further comprises correlating a magnitude of the change in the electrical resistance with a magnitude of the change in the liquid-container parameter.

In another example, the liquid comprises a fissile molten salt material.

In another example, the change in the electrical signal from one or more circuits of the series of circuits further indicates a leakage portion within the liquid-containing structure, wherein the leakage portion is defined by the corresponding adjacent pair of electrodes.

In addition to the example aspects described above, further aspects and examples will become apparent by reference to the drawings and by study of the following description.

### BRIEF DESCRIPTION OF THE DRAWINGS

FIG. 1 depicts a schematic block diagram of an example ex-situ measurement apparatus for performing a series of measurements on a vessel or pipe containing liquids.

FIG. 2 depicts an example vessel or pipe with a plurality of spaced electrodes.

FIG. 3 depicts a cross-sectional view of an example vessel or pipe.

FIG. 4 depicts an example circuit diagram of a vessel or pipe with equivalent resistance. FIG. 5 depicts a cross-sectional view of an example system vessel or pipe.

FIG. 6 depicts another example circuit diagram of a vessel or pipe with equivalent resistance.

FIG. 7 depicts an example semi-cylindrical tank jacket for a vessel or pipe.

FIG. 8 depicts a series of resistance measurements made with a plurality of electrodes mounted on exterior of a vessel or pipe.

FIG. 9 depicts a series of level measurements made with a plurality of electrodes mounted on exterior of a vessel or pipe.

FIG. 10A depicts an example leakage detection by a series of resistance measurements made with a plurality of electrodes mounted on exterior of a vessel or pipe.

FIG. 10B depicts another example leakage detection by a series of resistance measurements made with a plurality of electrodes mounted on exterior of a vessel or pipe.

FIG. 11 depicts an example molten salt reactor.

FIG. 12 depicts a flow diagram of an example method of conducting ex-situ measurements on a vessel or pipe.

FIG. 13 depicts a functional block diagram of a computing system.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to ex-situ measurement apparatuses, systems and methods of use thereof. For example, disclosed herein are certain ex-situ measurement systems and apparatuses that may be used to detect fluid level, fluid corrosivity, fluid species, coating health, void fraction, and fluid leakage (including a location of said leakage) of a conducting fluid relative to various types of process equipment. As used herein, “process equipment” may refer to substantially any type of commercial or industrial equipment that is used to move or process a substance, including generally any types of tanks, vessels, pipes, pumps, instrumentation, valves, and so on. In this regard, process equipment may refer herein to equipment that is used to handle fluids associated with energy production, including the production of heat from nuclear reactors, such as molten salt nuclear reactors. In the illustrated examples herein, example process equipment is described in relation to vessels or pipes in molten salt reactors (MSRs); however, it will be appreciated that this is for purpose of illustration, and that the example ex-situ measurement apparatuses, systems and methods of use thereof may be applicable to substantially any other process equipment, and the ex-situ measurement apparatuses and systems of the present disclosure may be configured to detect corrosion, coating health and leakage of said process equipment. The conducting fluid may therefore include a fuel salt including a fissile material therein, and the ex-situ measurement apparatuses and systems of the present disclosure may be configured to detect fluid level, fluid corrosivity, fluid species, void fraction, and fluid leakage of said fuel salt. Additionally or alternatively, the conducting fluid may comprise a natural and/or artificial fluid with an electrical response, including one or more of a liquid metal, water, a nano fluid and/or another fluid, and the ex-situ measurement apparatuses and systems of the present disclosure may be configured to detect fluid level, fluid corrosivity, fluid species, void fraction, and fluid leakage of said fluids.

With reference to MSRs, MSRs offer an approach to power that can utilize molten salts as their nuclear fuel in place of the conventional solid fuels used in light water reactors. Advantages include efficient fuel utilization and enhanced safety (in part due to replacing water as a coolant with molten salt). In some MSRs, fission reactions can occur within a molten salt composition housed with a reactor vessel. In certain conventional MSRs, fuel salt undergoes a fission reaction in a reactor vessel. Such conventional MSRs may operate by pumping the fuel salt from the reactor vessel along a “loop,” first to a primary heat exchanger, and then back to the reactor vessel so that the fuel salt may re-enter the reactor vessel for subsequent fission reactions. The reactor vessel, pump(s), heat exchanger(s) and/or other components may be fluidly coupled to one another by a series of pipes, flanges, and other connections, which may each present the possibility for leaks or other failure mechanisms. In some conventional systems, the functional components of the MSR may be arranged fully within an integral enclosure in order to form an integral or “pool-type” reactor whereby the fuel salt circulates between a reactor core and heat exchangers within a common vessel.

Any of the foregoing components, assemblies, subassemblies of such MSRs and similar systems may collectively be referred to as “process equipment.” This includes the reactor vessel, pump(s), heat exchanger(s) and/or other components that may be fluidly coupled to one another by a series of pipes, flanges, and other connections, which may each present the possibility for leaks or other failure mechanisms. Besides, the process equipment may contain hazardous substances, potentially including radioactive materials. To ensure the safe and stable operation of MSRs, it is crucial to continuously monitor the process equipment through ex-situ measurements, with the results promptly relayed to system administrators. Current measurement approaches rely on a limited set of sensors installed within the process equipment for in-situ measurement. However, operating in high-radiation and high-temperature environments places significant constraints on these sensors, severely limiting their functionality. Moreover, traditional approaches often lack the flexibility needed for easy maintenance and replacement of these sensors in such harsh conditions. Therefore, there is a pressing need for advanced ex-situ measurement systems capable of operating effectively in high-radiation and high-temperature environments. These systems should provide comprehensive state data, including fluid level, fluid corrosivity, fluid species, coating health, void fraction, and leakage location, among other parameters, to address the challenges associated with monitoring and maintaining the integrity of process equipment in MSRs and similar settings.

To address these formidable challenges and others, disclosed herein are certain ex-situ measurement systems and apparatuses designed for conducting measurements on various liquid-containing process equipment, even those situated in high-radiation, high-temperature environments. In one example, the ex-situ measurement system generally includes a series of sensors, such as electrodes, strategically affixed to the exterior of the process equipment, alongside a computing device. These electrodes are arranged to form a series of circuits upon contact with the liquid-containing process equipment, which may contain conducting fluids, such as molten salt solutions. Upon contact with said process equipment and subsequent charging by an electrical source, the electrodes exhibit changes in electrical signals. As one illustration, the ex-situ measurement systems and apparatuses may input a series of electrical signals, such as currents and voltages in different frequencies, through the electrodes and measure response electrical signals, such as currents, potentials, resistance, or capacitance. Variations in these electrical signals may occur, corresponding to the quantity and location of the conducting fluid that interacts with the electrodes, as described in greater detail herein. Further, the change in electrical resistance, capacitance and/or other parameters may generally occur and be detectable notwithstanding the arrangement of the electrodes in a high-radiation or high-temperature environment. The electrodes may therefore be arranged proximal to certain process equipment, including process equipment of MSRs that may be arranged in high-radiation or high-temperature environments, to conduct ex-situ measurements.

To facilitate the foregoing, the ex-situ measurement system and apparatus may be a tank jacket with an insulative material wherein a series of electrodes are embedded into the jacket. The insulative material may be a fabric material, such as a Kaowool ceramic insulation or like material, that does not conduct electrical current through. The fabric material may be substantially permeable or otherwise adapted to absorb and hold a quantity of fluid therein. The jacket may serve as a crucial structural element to the ex-situ measurement system and apparatus. Specifically, the electrodes, key components of the ex-situ measurement system and apparatus, may be associated with the jacket to form a composite apparatus for attachment with the process equipment.

In practice, the jacket may wrap around the curved side of the process equipment with a series of belts, ensuring that the electrodes maintain consistent contact with the process equipment's external surface. Upon contact with the process equipment and subsequent charging by an electrical source, the jacket may also exhibit electrochemical properties, influencing the electric fields generated by the charged electrodes. These electrodes, strategically positioned within the jacket, create electrical circuits that interact with the fluid contained within the process equipment. As the fluid-containing process equipment comes into contact with the electrodes, changes in electrical parameters occur. For instance, variations in electrical resistance or capacitance may be detected, providing insights into the fluid's properties such as level, composition, or other relevant parameters. The configuration of the ex-situ measurement system and apparatus enables precise and continuous monitoring of these changes in electrical parameters, allowing for real-time analysis and feedback. Further details regarding the measurement methodology and data interpretation are provided in subsequent sections.

The ex-situ measurement apparatus of the present disclosure may include or be used in cooperation with one or more computing devices in order to establish an ex-situ measurement system. For example, the ex-situ measurement apparatus, including the electrodes and jacket may be arranged proximal to the process equipment and within a potentially high-radiation and high-temperature environment. Said ex-situ measurement apparatus may be electrically coupled to one or more computing systems that are arranged generally outside of the high-radiation and high-temperature environment. For example, the ex-situ measurement apparatus may be coupled with the one or more computing systems via a series of wires or cables that extend from the electrodes and transverse a boundary of the high-radiation, high-temperature environment to reach the one or more computing systems. The one or more computing systems may be operable, among other functions, to register a baseline electrical output of the ex-situ measurement apparatus, such as the resistance, capacitance, potential, or current values obtained from the process equipment is normal operations. In turn, the one or more computing systems may detect a change in the electric output of the ex-situ measurement apparatus relative to the baseline and correlate said change with changes in fluid parameters from the associated process equipment. In some cases, as described herein, the one or more computing devices may further be operable to determine the fluid level, fluid species, fluid corrosivity, coating health, void fraction, and fluid leakage.

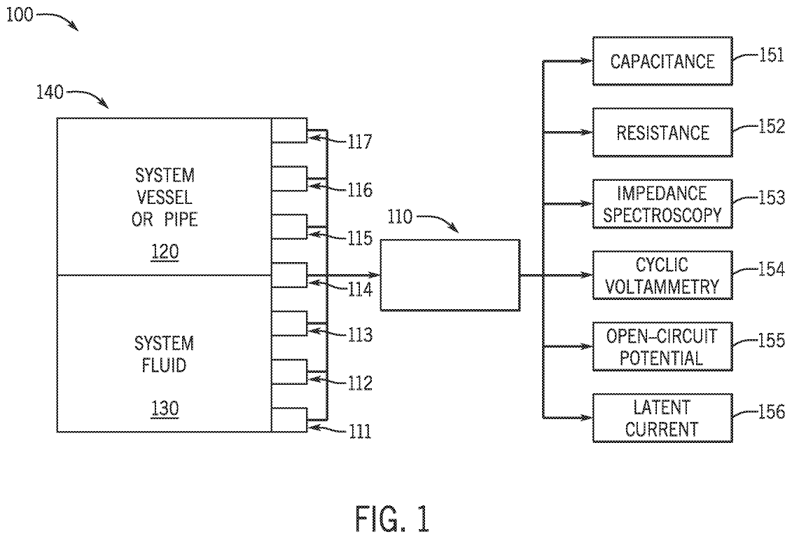

Turning to the drawings, for purposes of illustration, FIG. 1 depicts a schematic representation of an ex-situ system 100 for performing a series of measurements on a system vessel or pipe 120 containing a system fluid 130. The ex-situ system 100 includes an ex-situ measurement apparatus 110 and a plurality of contact sensors 111-117. The ex-situ measurement apparatus 110 may implement a series of electrical measurements and any of the functionalities described herein. As will be understood and appreciated, the example shown in FIG. 1 represents merely one example configuration of an ex-situ system 100 in which such system may be utilized. For example, the system vessel or pipe 120 can be any other process equipment, such as tank, pump, and so on. It will be understood that the ex-situ system 100 described herein may be used in and with substantially any other configuration of a molten salt reactor, as contemplated herein.

As illustrated in FIG. 1, the plurality of contact sensors 111-117 are positioned on exterior 121 of the system vessel or pipe 120 and are connected to the ex-situ measurement apparatus 110 via cables or wires. The system vessel or pipe 120 and the system fluid 130 form a vessel-fluid system 140, wherein the fluid 130, e.g., molten salt, is used as nuclear fuel of a molten salt reactor. In one example, the plurality of contact sensors 111-117 can be a plurality of equally spaced electrodes, wherein each adjacent pair of the electrodes form a circuit with a segment of the liquid-containing structure spanning therebetween. The adjacent pair of electrodes are further configured to measure electrochemical properties of the vessel-fluid system 140 by using different metrics and techniques, such as capacitance 151, resistance 152, impedance spectroscopy 153, cyclic voltammetry 154, open-circuit potential 155, and latent current 156.

In one example, the ex-situ measurement apparatus 110 is configured to measure and monitor a series of electrical parameters, including voltage, current, and resistance, from the plurality of electrodes 111-117. By comparing the electrical parameters measured from the electrodes 111-117, the ex-situ measurement apparatus 110 can detect the presence of liquid and further estimate the liquid level within the vessel or pipe 120. In addition, the ex-situ measurement apparatus 110 can determine chemical species of the fluid 130 within the vessel or pipe 120 by comparing the capacitance measurements with reference or baseline values. Furthermore, measurements of deviation from baseline electrical parameters calibrations or variance across the system may indicate vessel interior mass loss or mass gain.

In another example, the ex-situ measurement apparatus 110 can detect the presence of liquid and estimate the liquid level within the vessel or pipe 120 based on parallel circuit resistance measurements 152 from the plurality of electrodes 111-117. Normally, electrical resistance measurements are expected to remain steady for a large vessel and fluctuate only as a function of temperature in a short term. Within the vessel 120, a parallel resistance is induced through the interface between the vessel 120 and fluid 130, such as molten salt. It may therefore be desirable to perform a series of measurements with the plurality of electrodes 111-117 to perceive the changes of parallel resistance as the fluid 130 fills the vessel 120 and correlate the changes with the fluid level. Additionally, the drift in calibrated resistance or drift in relative resistances between the different pairs of electrodes 111-117 under static operation can indicate vessel interior degradation. Further, the resistance measurement can also be used for fuel void detection. For example, the ex-situ measurement apparatus 110 can monitor the dynamic resistance changes to determine whether the non-conductive species are wetting the vessel interior surface.

As another example, the ex-situ measurement apparatus 110 is configured to use impedance spectroscopy 153 to measure resistance across different frequencies. In the present disclosure, the impedance spectroscopy is used for level detection, vessel interior degradation analysis, and ion concentration and fuel homogeneity assessments. For example, the ex-situ measurement apparatus 110 can measure a series of parallel resistance across different signal frequencies and electrode pairs. Each of the resistance values corresponds to each pair of the spaced electrodes mounted on different positions of the vessel or pipe. Based on these resistance measurements, the ex-situ measurement apparatus 110 can determine the fluid level and identify loss of vessel materials. By correlating the resistance measurements with fluid's properties, the ex-situ measurement apparatus 110 can also identify spatially variant fluid properties, such as ion concentration and fuel homogeneity.

As another example, the ex-situ measurement apparatus 110 is configured to use cyclic voltammetry 154 for fuel testing and analysis, redox potential (also known as oxidation/reduction potential) measurements, and vessel passivation quantification. For example, by adjusting the voltage inputs to the electrodes 111-117 and measuring the current responses from the vessel-fluid system 140, the ex-situ measurement apparatus 110 can identify the chemical species within in the fluid 130. Moreover, the ex-situ measurement apparatus 110 may monitor redox potentials—the voltages where maxima and minima current can be measured—to evaluate the tendency of the fluid 130 to either acquire or lose electrons in a reaction and inform a system administrator to change fluid chemistry based on the evaluation.

With respect to vessel passivation quantification, the ex-situ measurement apparatus 110 is configured to monitor the open-circuit potential 155 over time and any shifts towards more negative potentials may suggest potential degradation of vessel structure and indicate the present of vessel passivation. Additionally, cyclic voltammetry 154 can be conducted to characterize the passive film formed on the vessel surface and the ex-situ measurement apparatus 110 is configured to analyze the monitored the cyclic voltammetry 154 curve to evaluate passivation quality and provide a comprehensive assessment of vessel passivation. The ex-situ measurement apparatus 110 can further quantitatively assess vessel passivation rate by monitoring the latent current 156. As latent current is the small and steady-state current observed by the apparatus 110 under passive conditions, it represents the rate of dissolution of the passive layer formed on the vessel surface. For example, a lower latent current indicates slower dissolution of the passive layer and better passivation. Therefore, by monitoring the changes of latent current and comparing it with baseline observations, the ex-situ measurement apparatus 110 can further provide the rate of passivation on the vessel surface.

As another example, the ex-situ measurement apparatus 110 can detect corrosion on the vessel 120 by measuring the vessel-fluid system's 140 innate electrical potential within the fluid 130. For example, the ex-situ measurement apparatus 110 measure the voltages between paired electrodes 111-117 that are spatially across the vessel 120. Then the measured voltages can be correlated to the presence of corrosion reactions and the specific stoichiometry/variety of the corrosion reactions within the fluid 130. By forming a pair of electrodes between different components, the ex-situ measurement apparatus 110 can identify the location of galvanic cells and predict the location where the corrosion will occur.

In a similar manner, the ex-situ measurement apparatus 110 can measure the vessel-fluid system's 140 innate electrical current within the system fluid 130 to detect corrosion on the vessel 120. As corrosion reactions usually involve the movement of charge (i.e., a current), a current measurement between two electrodes (e.g., paired electrodes) can indicate the presence of corrosion. Therefore, measuring the system innate electrical current allows the ex-situ measurement apparatus 110 to identify the presence of corrosion and begin quantitative predictions.

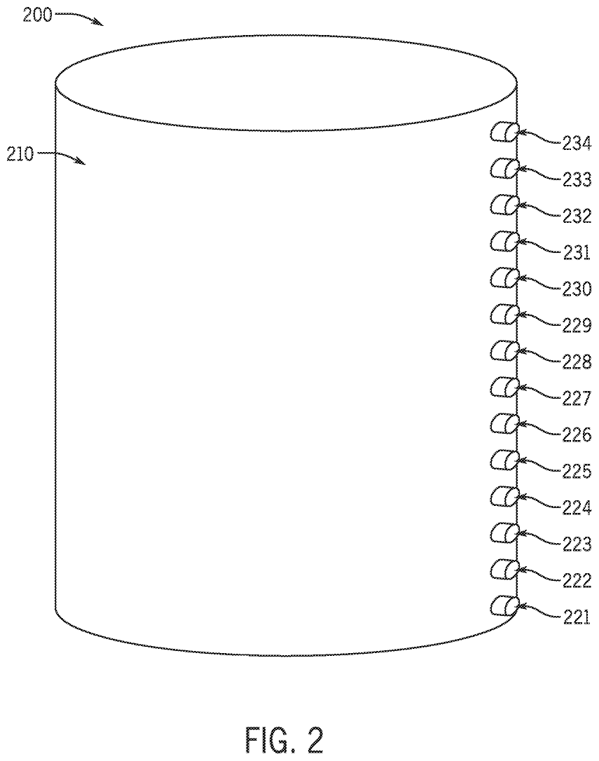

With reference to FIG. 2, an example vessel or pipe 200 with a plurality of equally spaced electrodes 221-234 is disclosed. In the present disclosure, the vessel or pipe 200 can be any vessel or pipe filled with a system fluid (e.g., molten salt) in a nuclear reactor system. In some examples, the vessel or pipe 200 can be any other process equipment, such as a tank or a pump. The plurality of protruding electrodes 221-234 are vertically mounted on the exterior 210 of the vessel or pipe 200. The electrodes 221-234 can be any metallic electrodes and each adjacent pair of the electrodes 221-234 form a circuit with a segment of the liquid-containing structure spanning therebetween. For example, an electrode 221 is paired with an electrode 222 and both are connected to an electric source via cables or wires. When the electrode 221 is positively charged and the electrode 222 that is negatively charged, the paired electrodes form a circuit with a segment of the liquid-containing structure spanning therebetween. Further, an ex-situ measurement apparatus can measure an electrical signal from the circuit and the electrical signal can be a measurement of resistance, capacitance, or current induced in the circuit.

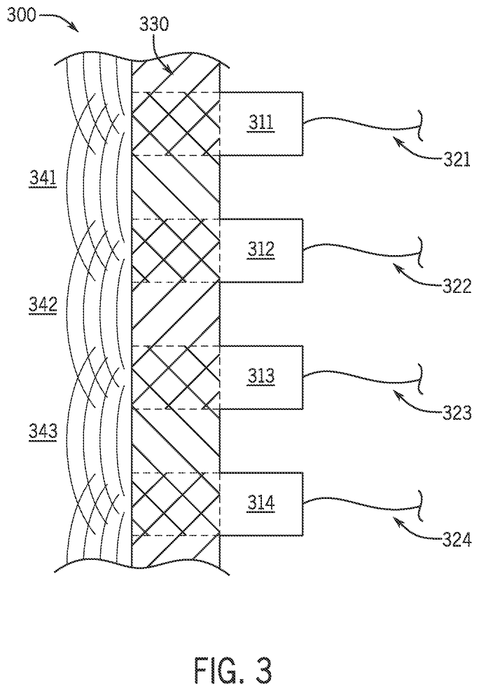

Turning to FIG. 3, a plurality of electrodes 311-314 used for ex-situ measurement in a vessel-fluid system 300 are shown in greater detail. Each of the electrodes 311-314 is equipped with a cable 321-324 to connect with an ex-situ measurement apparatus. The ex-situ measurement apparatus sends electrical signals to the vessel-fluid system 300 through the electrodes 311-314 and measures its responses.

In the example of FIG. 3, the electrodes 311-314 are vertically mounted across the exterior 330 of the vessel-fluid system 300. When the ex-situ measurement apparatus charges the electrodes 311-314 with voltages supplied through the cables 321-324, electromagnetic fields 341-344 will be established between adjacent electrodes within the system 300. The ex-situ measurement apparatus may measure the electrical signals invoked by the fluid and vessel or pipe wall segmented by the spaced electrodes 311-315.

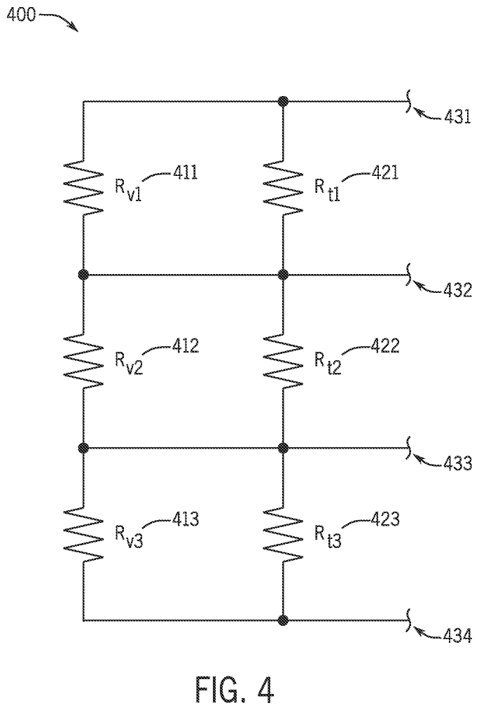

For example, an equivalent resistance circuit diagram is illustrated in FIG. 4. The equivalent electrical resistances of fluid segments between electrodes 431-434 are Rᵥ₁ 411, Rᵥ₂ 412, and Rᵥ₃ 413, respectively. The equivalent electrical resistances of vessel or pipe wall segments between the electrodes 431-434 are Rₜ₁ 421, Rₜ₂ 422, and Rₜ₃ 423, respectively. In particular, the resistances Rᵥ₁ 411 and Rₜ₁ 421 form a parallel resistance circuit between the electrodes 431 and 432; the resistances Rᵥ₂ 412 and Rₜ₂ 422 form a parallel resistance circuit between the electrodes 432 and 433; and the resistances Rᵥ₃ 413 and Rₜ₃ 423 form a parallel resistance circuit between the electrodes 433 and 434.

In one example, when the electrode 431 is positively charged and the electrode 432 is negatively charged, the ex-situ measurement apparatus may measure and monitor electrical current passing through the resistances Rᵥ₁ 411 and Rₜ₁ 421. The equivalent resistance in the parallel circuit can be obtained by the following formula:

$${R}_{431 - 432} = \frac{{R}_{v 1} {R}_{t 1}}{{R}_{v 1} + {R}_{t 1}} . \qquad ( 1 )$$

In another example, when the electrode 431 is positively charged and the electrode 433 is negatively charged, the ex-situ measurement apparatus may measure and monitor electrical current passing through the resistances Rᵥ₁ 411, Rᵥ₂ 412, Rₜ₁ 421, and Rₜ₂ 422. The equivalent resistance in the circuit between the electrodes 431 and 433 can be obtained by the following formula:

$${R}_{431 - 433} = \frac{{R}_{v 1} {R}_{t 1}}{{R}_{v 1} + {R}_{t 1}} + \frac{{R}_{v 2} {R}_{t 2}}{{R}_{v 2} + {R}_{t 2}} . \qquad ( 2 )$$

Furthermore, when the electrode 431 is positively charged and the electrode 434 is negatively charged, the ex-situ measurement apparatus may measure and monitor electrical current of the circuit between the electrodes 431 and 434. In this regard, the equivalent resistance is given by

$${R}_{431 - 434} = \frac{{R}_{v 1} {R}_{t 1}}{{R}_{v 1} + {R}_{t 1}} + \frac{{R}_{v 2} {R}_{t 2}}{{R}_{v 2} + {R}_{t 2}} + \frac{{R}_{v 3} {R}_{t 3}}{{R}_{v 3} + {R}_{t 3}} . \qquad ( 3 )$$

With reference to FIG. 5, another plurality of electrodes 511-514 used for ex-situ measurement in a vessel-fluid system 500 are shown in greater detail. The plurality of electrodes 511-514 may be substantially analogous to the plurality of electrodes 311-314 described herein in relation to FIGS. 3 and 4 and be configured to connect with an ex-situ measurement apparatus for electrochemical measurements.

Notwithstanding the foregoing similarities, the plurality of electrodes 511-514 generate electromagnetic fields 541-543 towards exterior of the system 500 when they are charged by the electrical source of the ex-situ measurement apparatus. The ex-situ measurement apparatus may measure the electrical signals invoked by the vessel or pipe wall 530 and exterior coating or insulative layer segmented by the spaced electrodes 511-514. In some examples, the exterior coating or insulative layer may be the material of a tank jacket wrapping around the vessel-fluid system 500, as described in greater detail below.

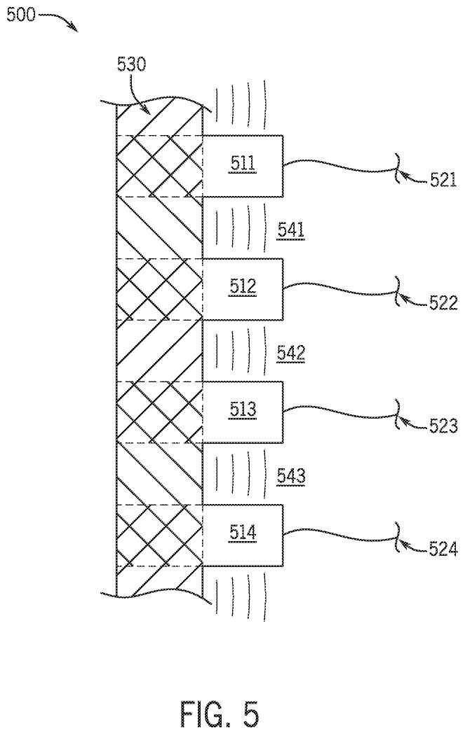

As illustrated in FIG. 6, the equivalent electrical resistances of vessel or pipe wall segments between the spaced electrodes 631-634 are Rᵥ₁ 611, Rᵥ₂ 612, and Rᵥ₃ 613, respectively. The equivalent electrical resistances of the exterior coating or insulative layer between the spaced electrodes 631-634 are Rₑ₁ 621, Rₑ₂ 622, and Rₑ₃ 623, respectively. In particular, the resistances Rᵥ₁ 611 and Rₑ₁ 621 form a parallel resistance circuit between electrodes 631 and 632; the resistances Rᵥ₂ 612 and Rₑ₂ 622 form a parallel resistance circuit between electrodes 632 and 633; and the resistances Rᵥ₃ 613 and Rₑ₃ 623 form a parallel resistance circuit between electrodes 633 and 634.

In one example, when the electrode 631 is positively charged and the electrode 632 is negatively charged, the ex-situ measurement apparatus may measure and monitor electrical current passing through the resistances Rᵥ₁ 611 and Rₑ₁ 621. The equivalent resistance in the parallel circuit can be obtained by the following formula:

$${R}_{631 - 632} = \frac{{R}_{v 1} {R}_{e 1}}{{R}_{v 1} + {R}_{e 1}} . \qquad ( 4 )$$

In another example, when the electrode 631 is positively charged and the electrode 633 is negatively charged, the ex-situ measurement apparatus may measure and monitor electrical current passing through the resistances Rᵥ₁ 611, Rᵥ₂ 612, Rₑ₁ 621, and Rₑ₂ 622. The equivalent resistance in the circuit between the electrodes 631 and 633 can be obtained by the following formula:

$${R}_{631 - 633} = \frac{{R}_{v 1} {R}_{e 1}}{{R}_{v 1} + {R}_{e 1}} + \frac{{R}_{v 2} {R}_{e 2}}{{R}_{v 2} + {R}_{e 2}} . \qquad ( 5 )$$

Furthermore, when the electrode 631 is positively charged and the electrode 634 is negatively charged, the ex-situ measurement apparatus may measure and monitor electrical current of the circuit between the electrodes 631 and 634. In this regard, the equivalent resistance is given by

$${R}_{631 - 634} = \frac{{R}_{v 1} {R}_{e 1}}{{R}_{v 1} + {R}_{e 1}} + \frac{{R}_{v 2} {R}_{e 2}}{{R}_{v 2} + {R}_{e 2}} + \frac{{R}_{v 3} {R}_{e 3}}{{R}_{v 3} + {R}_{e 3}} . \qquad ( 6 )$$

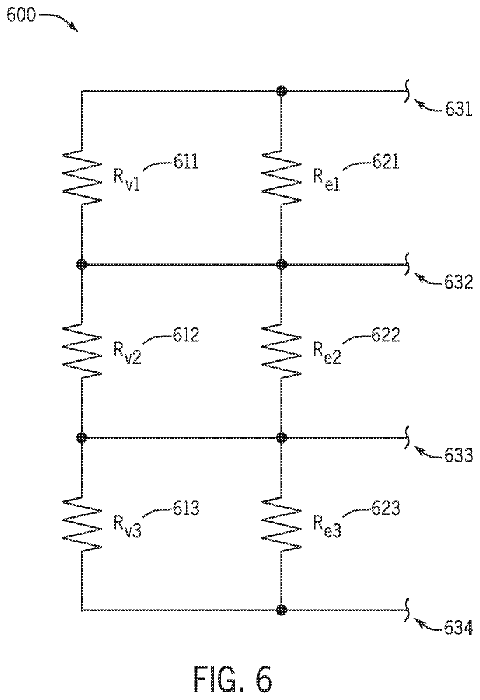

With reference to FIG. 7, an example semi-cylindrical tank jacket 700 is illustrated. The semi-cylindrical tank jacket 700 can wrap around the curved side of processing equipment (e.g., tank, vessel, pipe, pump, and so on). In the present disclosure, the tank jacket 700 may include an insulative layer 710 and a plurality of electrodes 711-724. The electrodes 711-724 further connect to ex-situ measurement apparatuses via a plurality of cables or wires 741-754. The insulative layer 710 may be a fabric material, such as a Kaowool ceramic insulation or like material, that does not conduct electrical current through. The fabric material may be substantially permeable or otherwise adapted to absorb and hold a quantity of fluid therein. The jacket may serve as a crucial structural element to an ex-situ measurement system. Specifically, the electrodes 711-724, key components of the ex-situ measurement system, may be associated with the jacket to form a composite apparatus for attachment with the process equipment.

As shown in FIG. 7, the electrodes 711-724 are evenly spaced apart in a vertical line and extend from the top to the bottom of the tank jacket 700, forming a continuous column. This vertical alignment enables precise measurement and monitoring of parameters such as capacitance, resistance, potential, current, or fluid level throughout the height of the processing equipment.

In some cases, the tank jacket 700 also comprises one or more pairs of belts 731-736 positioned along its two edges. On each edge of the tank jacket 700, there is a corresponding belt 731-733 that aligns and matches with its counterpart 734-736 on the opposite side. These belts 731-736 serve the crucial function of ensuring that the electrodes 711-724 maintain consistent contact with the processing equipment's surface. By securely fastening the tank jacket 700 in place, the belts 731-736 ensure that the electrodes 711-724 remain in close proximity to the processing equipment at all times, optimizing their ability to accurately measure and monitor various parameters such as capacitance, resistance, potential, current, or fluid level. In practice, the jacket 700 may also exhibit electrochemical properties when the electrodes 711-724 are charged by an electrical source. These electrodes, strategically positioned within the jacket, create electrical circuits that interact with the fluid contained within the process equipment and the insulative layer 710 of the jacket 700, wherein the insulative layer 710 may influence the electric fields generated by the charged electrodes. The ex-situ measurement apparatus may detect the variations in electrical signals (e.g., current, capacitance, resistance, potential, and so on) and provide insights into the fluid's properties such as fluid level, fluid composition, fluid species, or other relevant parameters.

Notwithstanding the foregoing, the tank jacket 700 may include a variety of alternative structures capable of fulfilling the aforementioned functionalities. For example, the jacket 700 may adopt a cylindrical form, offering flexibility in its physical placement across diverse configurations. Moreover, beyond the fabric material used in the insulative layer 710, the jacket 700 may incorporate a range of alternatives materials, such as polymers, mineral, clay, or composite, ensuring adaptability to specific operation requirements and environment conditions.

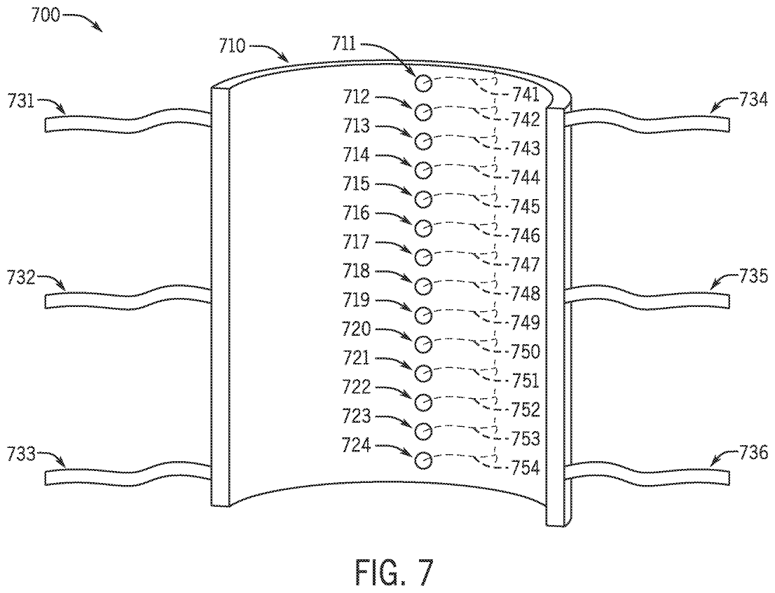

FIG. 8 depicts a series of resistance measurements made within a vessel-fluid system 801. The vessel-fluid system 801 can be any process equipment (e.g., vessels, tanks, pipes, pumps, and so on) that contains a fluid 850. A plurality of electrodes 821-826 mounted along the exterior wall 830 of the system 801 may be evenly spaced apart and arranged in a vertical line or any other suitable configuration. Each pair 811-815 of adjacent electrodes 821-826 forms a unique configuration to create an electric circuit within the vessel-fluid system 801. By applying a voltage across the paired electrodes 811-815, an electric field is established, which interacts with the gas 840 and fluid 850 within the vessel-fluid system 801. The resistances between the paired electrodes can be measured and monitored by using suitable instrumentation, e.g., an ex-situ measurement apparatus.

In operation, the ex-situ measurement apparatus monitors and records changes in the resistance between the paired electrodes 811-815 over time. Furthermore, the ex-situ measurement apparatus can display a graphical representation 860 of resistance values versus electrode pairs 811-815 based on the resistance measurements obtained from the electrodes 821-826. This allows system administrators to monitor and analyze resistance changes over different paired electrodes 811-815, providing valuable insights into the condition and characteristics of the fluid within the vessel-fluid system 801.

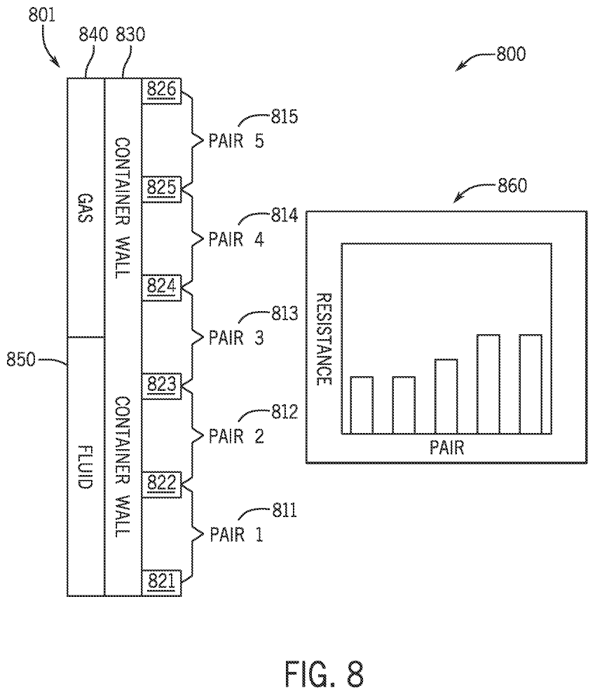

With reference to FIG. 9, a second example ex-situ measurement is made within a vessel-fluid system 901 for fluid level detection. The vessel-fluid system 901, electrodes 911-917, and ex-situ measurement apparatus 910 may be substantially analogous to those described herein in relation to FIGS. 1 and 8. They can be configured to measure spatial parallel resistance of the fluid 930 through the electrodes 911-917 mounted on the exterior of process equipment 920 (e.g., e.g., vessels, tanks, pipes, pumps, and so on); redundant explanation of which is omitted herein for clarity.

In operation, the ex-situ measurement apparatus 910 measures changes in the resistance over time and correlates the changes with the fluid level. Furthermore, the ex-situ measurement apparatus 910 can display a graphical representation 940 of the fluid level versus time based on the resistance measurements obtained from the electrodes 911-917. This feature allows users to visualize changes in fluid level over time, providing valuable insights into dynamics and behavior of the fluid 930 within the process equipment 920.

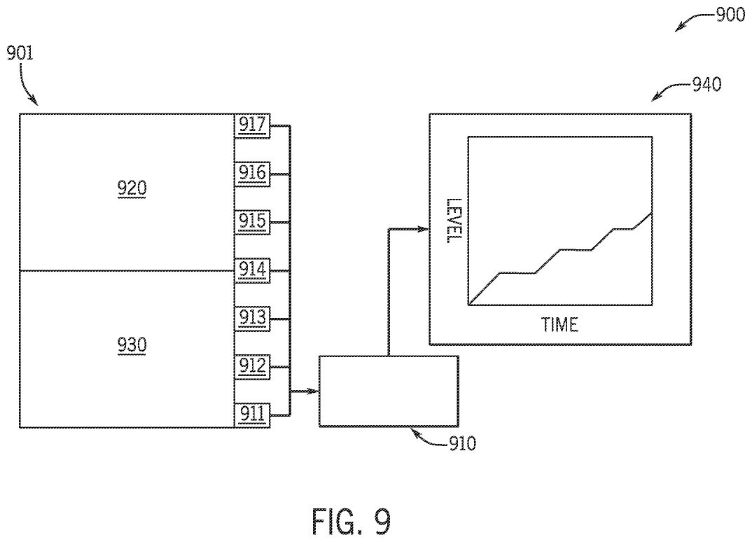

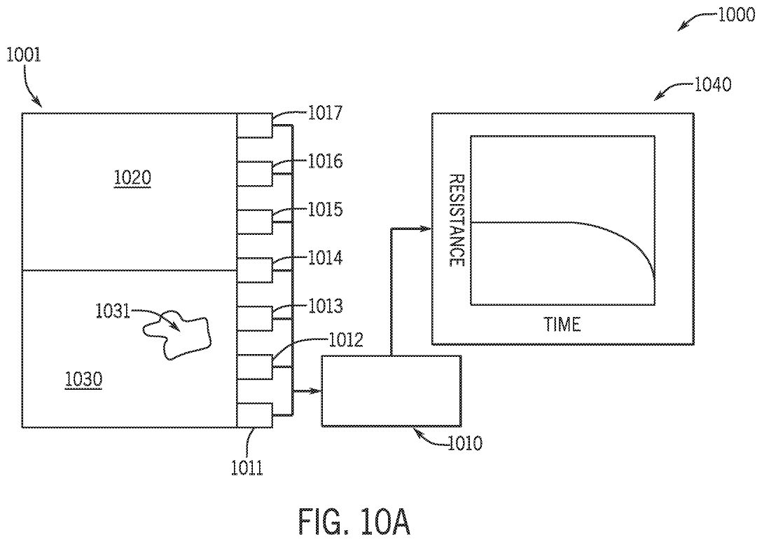

FIG. 10A illustrates the use of an ex-situ measurement apparatus 1010 in a vessel-fluid system 1001 for fluid leakage detection. The vessel-fluid system 1001, electrodes 1011-1017, and ex-situ measurement apparatus 1010 may be substantially analogous to those described herein in relation to FIGS. 8-9. They can be configured to measure spatial parallel resistance of the fluid 1030 through the electrodes 1011-1017 mounted on the exterior of process equipment 1020 (e.g., e.g., vessels, tanks, pipes, pumps, and so on); redundant explanation of which is omitted herein for clarity.

In operation, the ex-situ measurement apparatus 1010 monitors changes in the resistance over time and correlates the changes with the fluid level. Under normal circumstances, the resistance remains relatively stable. However, a fluid leakage 1031 within the process equipment 1020 may cause abnormal fluctuations or sudden changes on the resistance between the electrodes 1011-1017. By continuously measuring the resistance obtained from the electrodes 1011-1017, the ex-situ measurement apparatus 1010 can effectively identify abnormal fluctuations indicative of the leakage event. Furthermore, the ex-situ measurement apparatus 1010 can display a graphical representation 1040 of the changes in resistance versus time based on the resistance measurements obtained from the electrodes 1011-1017. This feature allows users to visualize changes in resistance over time, providing valuable insights into dynamics and behavior of the fluid 1030 within the process equipment 1020, such as an occurrence of fluid leakage.

In another example, a plurality of ex-situ measurement apparatuses 1051-1055 can locate the position of fluid leakage 1031′ in a vessel-fluid system 1001′. As illustrated in FIG. 10B, the vessel-fluid system 1001′, electrodes 1011′-1016′, and ex-situ measurement apparatuses 1051-1055 may be substantially analogous to those described herein in relation to FIG. 10A. They can be configured to measure spatial parallel resistance of the fluid 1030′ through the electrodes 1011′-1016′ mounted on the exterior of process equipment 1020′ (e.g., e.g., vessels, tanks, pipes, pumps, and so on); redundant explanation of which is omitted herein for clarity.

In the present disclosure, the electrodes 1011′-1016′ are evenly spaced apart and arranged in a vertical line or any other suitable configuration. Each pair of adjacent electrodes 1011′-1016′ forms a unique configuration with an ex-situ measurement apparatus 1051-1055 and create an electric circuit within the vessel-fluid system 1001′. By applying a voltage across the paired electrodes 1011′-1016′, an electric field is established, which interacts with the fluid 1030′ within the process equipment 1020′. The resistance between the paired electrodes 1011′-1016′ is then measured and monitored by the ex-situ measurement apparatuses 1051-1055. For example, the ex-situ measurement apparatus 1051 measures the changes in the resistance between the paired electrodes 1011′ and 1012′ over time and correlates the changes with the fluid level. Similarly, the ex-situ measurement apparatus 1052 measures the changes in the resistance between the paired electrodes 1012′ and 1013′; the ex-situ measurement apparatus 1053 measures the changes in the resistance between the paired electrodes 1013′ and 1014′; the ex-situ measurement apparatus 1054 measures the changes in the resistance between the paired electrodes 1014′ and 1015′; and the ex-situ measurement apparatus 1055 measures the changes in the resistance between the paired electrodes 1015′ and 1016′. Each ex-situ measurement apparatus 1051-1055 further displays a graphical representation 1041-1045 of the monitored resistance versus time based on the measurements obtained from the electrodes 1011′-1016′. This allows system administrators to visualize changes in the resistance over time and locate the place where the fluid leakage occurs. For example, the graphical representation 1042 shows abnormal fluctuations of the resistance, indicating that the leakage area is most likely occurred between the paired electrodes 1012′and 1013′.

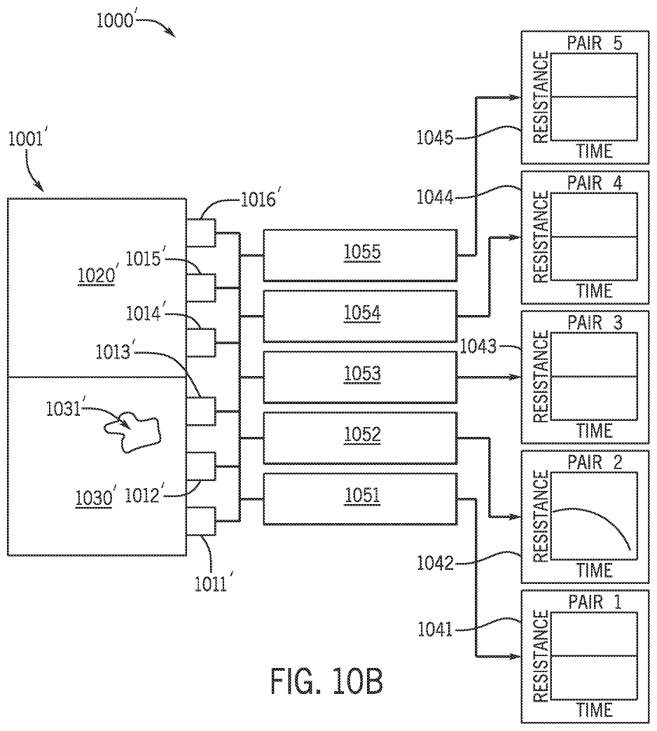

FIG. 11 depicts an example molten salt reactor system 1100. The molten salt reactor system 1100 is depicted and described herein to illustrate example process equipment with which the various ex-situ measurement apparatuses and systems of the present disclosure may be used. Accordingly, while the molten salt reactor system 1100 is described herein, it will be appreciated that such ex-situ measurement apparatuses and systems may be used with a variety of process equipment to measure electrochemical properties of conducting fluid being carried therethrough as described herein.

With reference to the molten salt reactor system 1100 of FIG. 11, the example molten salt reactor system 1100 of FIG. 11 utilizes fuel salt enriched with uranium (e.g., high-assay low-enriched uranium) to create thermal power via nuclear fission reactions. In at least one example, the composition of the fuel salt may be LiF—BeF₂—UF₄, though other compositions of fuel salts may be utilized as fuel salts within the reactor system 1100. The fuel salt within the system 1100 is heated to high temperatures (such as 600° C. or greater) and melts as the system 1100 is heated.

As shown in FIG. 11, the molten salt reactor system 1100 includes a reactor vessel 1104 where the nuclear reactions occur within the molten fuel salt, a fuel salt pump 1106 that pumps the molten fuel salt to a heat exchanger 1110, such that the molten fuel salt re-enters the reactor vessel after flowing through the heat exchanger 1110, and piping in between each component (e.g., piping 1112a, 1112b, 1112c, 1112d, 1112e). In one example, the ex-situ measurement apparatus and system may mount a plurality of electrodes along the exterior of the reactor vessel 1104. The plurality of electrodes may be evenly spaced apart and arranged in a vertical line or any other suitable configuration, as described herein in relation to FIG. 2. In another example, the ex-situ measurement apparatus and system may wrap a semi-cylindrical tank jacket, as described herein in relation to FIG. 7, around the reactor vessel 1104 to perform ex-situ measurements.

The molten salt reactor system 1100 may also include additional components, such as, but not limited to, drain tank 1108 and reactor access vessel 1102. The drain tank 1108 may be configured to store the fuel salt once the fuel salt is in the reactor system 1100 but in a subcritical state, and also acts as storage for the fuel salt if power is lost in the system 1100. The reactor access vessel 1102 may be configured to allow for introduction of small pellets of uranium fluoride (UF₄) to the system 1100 as necessary to bring the reactor to a critical state and compensate for depletion of fissile material. In some examples, it may be desirable to allow the ex-situ measurement apparatus and system to perform ex-situ measurements and monitor dynamics and behavior of the conducting fluid within these components.

FIG. 11 further shows the system 1100 as including an internal vessel or shield 1120 that defines a first thermally insulative region 1124 about select components of the system 1100. FIG. 11 further shows the system 1100 as including a reactor enclosure 1130. The reactor enclosure may be constructed from a thermally insulative metal (including certain stainless steels) that is capable of withstanding substantially high temperatures, such as temperature in excess of 600° C. The reactor enclosure 1130 is shown, schematically, as encompassing the entirety of the internal shield 1120 and any other salt-bearing components that are not otherwise included with the internal shield 1120. For example, the reactor enclosure 1130 may define a second thermally insulative region 1134 that receives the internal shield 1120 and all the salt-bearing components that are not held within the first thermally insulative region 1124. The internal shield 1120 and the reactor enclosure 1130 may therefore each define a containment barrier about the salt-bearing components of the system 1100. Further, the internal shield 1120 and the reactor enclosure 1130 may define a substantially high-radiation and high-temperature zone of the system 1100.

FIG. 11 further shows an ex-situ measurement apparatus 1140, such as any of the ex-situ measurement apparatuses described herein, configured to perform ex-situ measurements for piping components containing conducting fluid. For example, the ex-situ measurement apparatus 1140 may be associated with a pipe segment 1112d (e.g., the pipe run that extends between the heat exchanger 1110 and the drain tank 1108) and be configured to output an electrical signal indicative of a leak event of conducting fluid from the pipe segment 1112d, as described herein. While the ex-situ measurement apparatus is shown associated with the pipe segment 1112d, in other cases, the ex-situ measurement apparatus 1140 may be associated with substantially any tank, vessel, pipe, pump and/or other component of the system 1100 and/or other process equipment, according to the examples described herein. The ex-situ measurement apparatus 1140 is shown arranged in the high-temperature, high-radiation environment of the system 1100. Wire bundle 1142 is shown extending from the ex-situ measurement apparatus to a zone outside of the high-temperature, high-radiation zone, such as to one or more computing devices that may receive signals from the ex-situ measurement apparatus 1140 for analysis and providing valuable insights into dynamics and behavior of the fluid, such as determination of any interior degradation, corrosion, fluid leak events detected therewith.

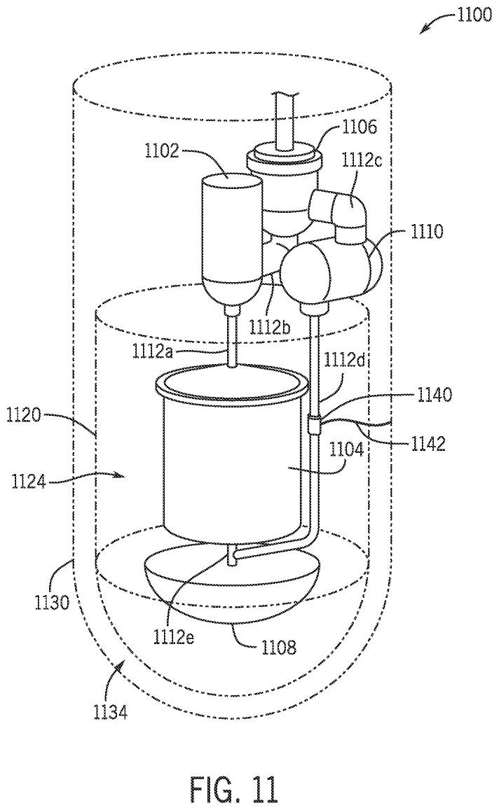

FIG. 12 depicts a flow diagram of an example process 1200 of performing ex-situ measurements. For example, at operation 1204, a conducting fluid containing component is operated. For example, and with reference to FIG. 11, a molten salt reactor system 1100 may be operated whereby a conducting fluid (e.g., a molten salt) is filled in a reactor vessel 1104 and circulated through various process equipment, as described herein. The conducting fluid may flow through pipe segments 1112a, 1112b, 1112c, 1112d, 1112e about a molten salt loop.

At operation 1208, an ex-situ measurement apparatus that is engaged with the conducting fluid containing component is operated. The ex-situ measurement apparatus may mount a plurality of electrodes along the exterior of process equipment (e.g., vessels, tanks, pipes, pumps, and so on). Besides, these electrodes are evenly spaced apart and arranged in a vertical line or any other suitable configuration. Each pair of adjacent electrodes forms a unique configuration to create an electrical circuit. The ex-situ measurement apparatus may be configured to conduct an electrical signal through a series of circuits defined by the adjacent paired electrodes by applying a voltage across the paired electrodes. An electric field is established, which interacts with the fluid within the process equipment.

At operation 1212, an ex-situ measurement apparatus is configured to measure and monitor changes in the electrical signals over time from one or more circuits defined by the adjacent paired electrodes. The electrical signals may include resistance, capacitance, potential, or current. For example, the ex-situ measurement apparatus may monitor changes in the resistance over time. Under normal circumstances, the resistance remains relatively stable. The ex-situ measurement apparatus may record and output certain baseline electrical signals, such as the resistance, capacitance, potential, or current values in normal operations. However, a fluid leakage within the process equipment may cause abnormal fluctuations or sudden changes on the resistance between the paired electrodes. By continuously measuring the resistance obtained from the paired electrodes, the ex-situ measurement apparatus can determine that a sudden change in said electrical signals corresponds to a fluid leakage event.

At operation 1216, an ex-situ measurement apparatus is configured to correlate changes in electrical signals to changes in the fluid parameters. For example, the ex-situ measurement apparatus may output one or more electric signals, e.g., measurements of resistance, capacitance, potential, or current, to a computing device. The computing device may include or otherwise be associated with a preamplifier, an ohmmeter, and visual display, among other components. In normal operations, such electric signals serve as baseline signals and may correlate to the normal fluid parameters, such as fluid levels. When a leak event happens, the ex-situ measurement apparatus may detect abnormal fluctuations or sudden changes of electric signals. Accordingly, the signals output by the ex-situ measurement apparatus may indicate a changed electrical resistance of a segment of the liquid-containing structure spanning between the paired electrodes. Said changed electrical resistance may be analyzed and displayed in a graphical representation, as described herein in relation to FIGS. 10A and 10B. The abnormal fluctuations and sudden changes in resistance, as shown in charts 1040 and 1042, may be indicative of said leak event. In some cases, the ex-situ measurement apparatus may include the computing device or otherwise include one of the preamplifier, the ohmmeter, and the visual display, among other components.

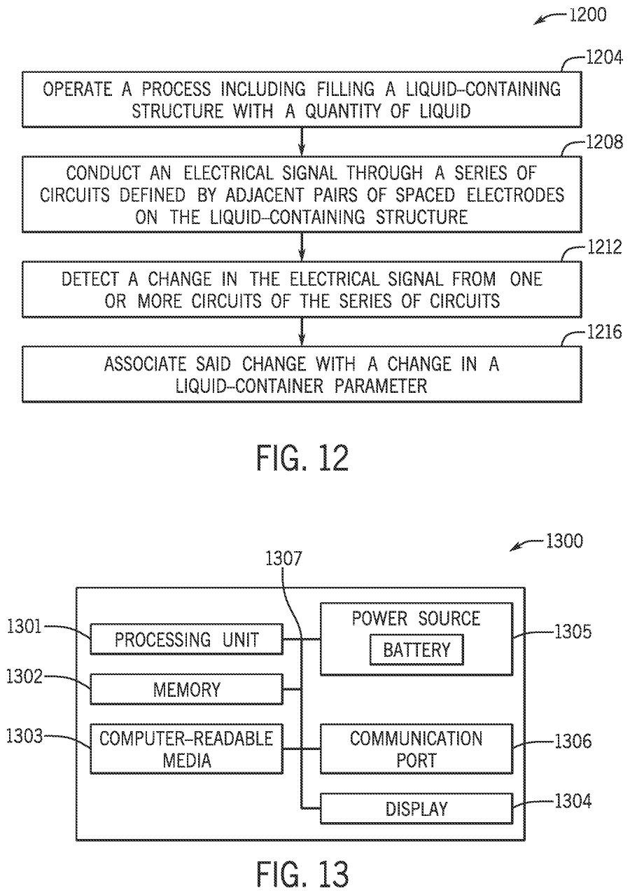

FIG. 13 depicts a functional block diagram of a computing system 1300. The schematic representation in FIG. 13 is generally representative of any types of systems and configurations that may be used to receive and process the various signals from the ex-situ measurement apparatus described herein. For example, the computing system 1300 may be used with or included within any of the ex-situ measurement apparatuses described herein to form or establish an ex-situ measurement system, and to perform any of the functions described herein. In this regard, the computing system 1300 may include any appropriate hardware (e.g., computing devices, data centers, switches), software (e.g., applications, system programs, engines), network components (e.g., communication paths, interfaces, routers) and the like (not necessarily shown in the interest of clarity) for use in facilitating any appropriate operations disclosed herein.

As shown in FIG. 13, the computing system 1300 may include a processing unit or element 1301 operatively connected to computer memory 1302 and computer-readable media 1303. The processing unit 1301 may be operatively connected to the memory 1302 and computer-readable media 1303 components via an electronic bus or bridge (e.g., such as system bus 1307). The processing unit 1301 may include one or more computer processors or microcontrollers that are configured to perform operations in response to computer-readable instructions. The processing element 1301 may be a central processing unit of control system 1300. Additionally or alternatively, the processing unit 1301 may be other processors within the device including application specific integrated chips (ASIC) and other microcontroller devices.

The memory 1302 may include a variety of types of non-transitory computer-readable storage media, including, for example, read access memory (RAM), read-only memory (ROM), erasable programmable memory (e.g., EPROM and EEPROM), or flash memory. The memory 1302 is configured to store computer-readable instructions, sensor values, and other persistent software elements. Computer-readable media 1303 may also include a variety of types of non-transitory computer-readable storage media including, for example, a hard-drive storage device, a solid state storage device, a portable magnetic storage device, or other similar device. The computer-readable media 1303 may also be configured to store computer-readable instructions, sensor values, and other persistent software elements.

In this example, the processing unit 1301 is operable to read computer-readable instructions stored on the memory 1302 and/or computer-readable media 1303. The computer-readable instructions may adapt the processing unit 1301 to perform the operations or functions described above with respect to FIGS. 1-12. The computer-readable instructions may be provided as a computer-program product, software application, or the like.

As shown in FIG. 13, the computing system 1300 may also include a display 1304. The display 1304 may include a liquid-crystal display (LCD), organic light emitting diode (OLED) display, light emitting diode (LED) display, or the like. If the display 1304 is an LCD, the display may also include a backlight component that can be controlled to provide variable levels of display brightness. If the display 1304 is an OLED or LED type display, the brightness of the display 1304 may be controlled by modifying the electrical signals that are provided to display elements.

The computing system 1300 may also include a battery that is configured to provide electrical power to the components of computing system 1300. The battery may include one or more power storage cells that are linked together to provide an internal supply of electrical power. In this regard, the battery may be a component of a power source 1305 (e.g., including a charging system or other circuitry that supplies electrical power to components of the computing system 1300). The battery may be operatively coupled to power management circuitry that is configured to provide appropriate voltage and power levels for individual components or groups of components within the computing system 1300. The battery, via power management circuitry, may be configured to receive power from an external source, such as an AC power outlet or interconnected computing device. The battery may store received power so that the computing system 1300 may operate without connection to an external power source for an extended period of time, which may range from several hours to several days.

The computing system 1300 may also include a communication port 1306 that is configured to transmit and/or receive signals or electrical communication from an external or separate device. The communication port 1306 may be configured to couple to an external device via a cable, adaptor, or other type of electrical connector. In some embodiments, the communication port 1306 may be used to couple the computing system 1300 with a computing device and/or other appropriate accessories configured to send and/or receive electrical signals. The communication port 1306 may be configured to receive identifying information from an external accessory, which may be used to determine a mounting or support configuration. For example, the communication port 1306 may be used to determine that the computing system 1300 is coupled to a mounting accessory, such as a particular type of stand or support structure.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. An ex-situ system for measuring liquid-container relationships, the system comprising
a series of spaced electrodes mounted on an exterior surface of a liquid-containing structure, wherein each adjacent pair of electrodes of the series of spaced electrodes form a circuit with a segment of the liquid-containing structure spanning therebetween; and
a computing device configured to detect a change in an electrical signal from each circuit and associate said change with a change in a liquid-container parameter.

2. The system of claim 1, wherein the liquid-container parameter comprises a liquid level of the liquid-containing structure.

3. The system of claim 1, wherein the liquid-container parameter comprises a liquid corrosivity of a liquid of the liquid-containing structure.

4. The system of claim 1, wherein the liquid-container parameter comprises a liquid species of a liquid of the liquid-containing structure.

5. The system of claim 1, wherein the liquid-container parameter comprises a coating health of a coating of the liquid-containing structure.

6. The system of claim 1, wherein the liquid-container parameter comprises a void fraction of the liquid-containing structure.

7. The system of claim 1, wherein the liquid container parameter comprises an indication of a liquid leak of a liquid of the liquid-containing structure.

8. The system of claim 1, wherein
each circuit is associated with a baseline electrical resistance through the corresponding segment of the liquid-containing structure, and
the change in the electric signal from each circuit is based on a change in a measured electrical resistance between two adjacent electrodes and through the liquid-containing structure relative to the corresponding baseline electrical resistance for said circuit.

9. The system of claim 1, wherein
each adjacent pair of electrodes of the series of spaced electrodes forms a secondary circuit with a portion of a volume of the liquid-containing structure corresponding to the respective segment, and
the computing device is configured to detect a change in an electrical signal from each secondary circuit and associate said change with a change in the liquid-container parameter.

10. The system of claim 9, wherein
each secondary circuit is associated with a baseline electrical resistance through the corresponding portion of the volume of the liquid-containing structure, and
the change in the electric signal from each secondary circuit is based on a change in a measured electrical resistance between two adjacent electrodes and through the corresponding portion of the volume of the liquid-containing structure relative to the corresponding baseline electrical resistance for said secondary circuit.

11. The system of claim 1, wherein the computing device is configured to detect and monitors changes of electrical resistance values between the adjacent electrodes.

12. The system of claim 1, wherein the computing device is configured to detect the change in the electrical signal using an impedance spectroscopy technique, wherein the impedance spectroscopy technique monitors changes of electrical resistance values between the adjacent electrodes in different signal frequencies.

13. The system of claim 1, wherein the computing device is configured to detect the change in the electrical signal using a cyclic voltammetry technique, wherein the cyclic voltammetry technique monitors changes of electric currents in different voltage inputs.

14. The system of claim 1, wherein the computing device is configured to detect the change in the electrical signal using an open-circuit potential technique, wherein the open-circuit potential technique monitors changes of electric potentials between the adjacent electrodes.

15. The system of claim 1, wherein the computing device is configured to detect the change in the electrical signal using a latent current technique, wherein the latent current technique monitors the presence and changes of electric currents between the adjacent electrodes.

16. A method of detecting a change in a liquid-container parameter, the method comprising
operating a process including filling a liquid-containing structure with a quantity of liquid, wherein the liquid-containing structure is associated with a series of spaced electrodes mounted along and electrically coupled with a side of the liquid-containing structure;
conducting an electrical signal through a series of circuits defined by corresponding adjacent pairs of electrodes of the series of spaced electrodes and a segments of the liquid- containing structure spanning therebetween; and
detecting a change in the electrical signal from one or more circuits of the series of circuits; and
associating said change with a change in a liquid-container parameter.

17. The method of claim 16, wherein each circuit is further defined by a portion of a volume of the liquid-containing structure corresponding to the respective segment such that the portion of the volume and the corresponding segment of the liquid-containing structure form a parallel resistive circuit.

18. The method of claim 16, wherein the liquid container parameter comprises one or more of
a liquid level of the liquid-containing structure,
a liquid corrosivity of a liquid of the liquid-containing structure,
a liquid species of a liquid of the liquid-containing structure,
a coating health of a coating of the liquid-containing structure,
a void fraction of the liquid-containing structure, or
an indication of a liquid leak of a liquid of the liquid-containing structure.

19. The method of claim 16, wherein
the detecting further comprises detecting a change in the electrical resistance of the electrical signal, and
the associating further comprises correlating a magnitude of the change in the electrical resistance with a magnitude of the change in the liquid-container parameter.

20. The method of claim 16, wherein the liquid comprises a fissile molten salt material.

21. The method of claim 16, wherein the change in the electrical signal from one or more circuits of the series of circuits further indicates a leakage portion within the liquid-containing structure, wherein the leakage portion is defined by the corresponding adjacent pair of electrodes.
